(19) United States
(12) Patent Application Publication
(10) Pub. No.: US 2015/0262131 A1
(43) Pub. Date: Sep. 17, 2015

(54) SYSTEM FOR IDENTIFYING PEOPLE AND ENTITIES TO MEET AND METHODS OF ITS USE

(71) Applicant: CEQUITY LLC, Spring Valley, NY (US)

(72) Inventor: Yakov Z. MERMELSTEIN, Spring Valley, NY (US)

(73) Assignee: CEQUITY LLC, Spring Lane, NY (US)

(21) Appl. No.: 14/702,050

(22) Filed: May 1, 2015

Related U.S. Application Data
(63) Continuation-in-part of application No. 13/800,058, filed on Mar. 13, 2013.

(51) Int. Cl. G06Q 10/10; G06Q 10/02

(52) U.S. Cl. CPC G06Q 10/1095; G06Q 10/02

(57) ABSTRACT

The herein method involves electronically searching for people and entities with a certain characteristic. Once these people and entities are identified, there is a search of to see if there is a commonly available time for a meeting, both with respect to time and location. Meetings scheduled for commonly available times are automatically inserted into electronic calendars curated by at least one of the meeting parties.

### CROSS-REFERENCE TO RELATED APPLICATIONS

This application is a continuation-in-part of U.S. patent application Ser. No. 13/800,058, filed Mar. 13, 2013, which is incorporated by reference herein in its entirety.

### FIELD OF THE INVENTION

This invention relates to the electronics and communications industry and, more particularly, to an electronic system for helping a person find relevant people and entities to meet.

### BACKGROUND OF THE INVENTION

In today's busy world, people are moving constantly. No one sits still anymore. This week, there is a conference in Las Vegas, and next week a trade show in Chicago. Along the way, you have people to meet in New York and elsewhere.

Especially while traveling, people need to be able to identify people and entities they desire to meet. Sometimes, these people and/or entities are already known, and other times they may be entirely new and unknown. As used herein, any of a user of the system, people identified by the system, and entities identified by the system, alone or in any combination, may be referred to as “party” or “parties”.

Therefore, there is a need in the industry for people to more quickly and efficiently identify the people and entities they want and/or need to meet.

### SUMMARY OF THE INVENTION

These and other objects of the invention are achieved with a system and method involving electronically searching for people and entities with a certain characteristic. Once these people and entities are identified, then there is a search to see if there is a common available time for a meeting, both with respect to time and location.

In some embodiments, the present disclosure is directed to a method for facilitating scheduling of meetings, comprising the steps of identifying potential entities with which an initiator can meet, establishing electronic communication between the initiator and the potential entities, identifying locations for the initiator and each potential entity for at least one time increment across a designated time frame from electronic calendars curated by the initiator and the potential entity, defining an initiator's desired characteristic in a desired entity, identifying desired entities from within the identified potential entities, identifying at least one time increment having common meeting availability for the initiator and the desired entity based on the identified locations for the initiator and the desired entities, and automatically inserting a meeting entry at the at least one common meeting availability into an electronic calendar.

In some embodiments, the initiator can override insertion of an automatic meeting entry. In some embodiments, the method for facilitating scheduling of meetings further comprises the step of identifying the desired entities in an order in which they are available to meet with the initiator. In some embodiments, the method for facilitating scheduling of meetings further comprises the step of identifying the desired entities in order of price.

In some embodiments, the potential entities are service providers or product retailers. In some embodiments, the desired characteristic is selected from the group consisting of: hours or operation, availability, price, service offered, product offered, crowd-sourced ratings, and combinations thereof. In some embodiments, the at least one common meeting availability includes both time and location availability.

In some embodiments, a location discrepancy between an actual location of the initiator or desired entity and the identified location of the initiator or desired entity is identified and the meeting entry is rescheduled.

In some embodiments, the present disclosure is directed to a method of coordinating an event for a user comprising the steps of providing a database of events and venues associated with the events, storing the database on a non-transitory computer-readable medium, identifying by a user a desired event from the database of events, determining at least one characteristic of the desired event, wherein the at least one desired characteristic is selected from the group consisting of: location of the event, location of the user, number of potential invitees, number of desired attendees, budget for the event, start time of the event, duration of the event, and combinations thereof, identifying venues from the database satisfying the at least one characteristic, and booking the venue for the desired event. In some embodiments, the step of booking the venue includes the step of determining characteristics that allow for a largest number of available potential invitees based on the scheduling information. In some embodiments, the method of coordinating an event further comprises the step of automatically inserting the desired event into electronic calendars curated by the user and the potential invitees.

In some embodiments, the method of coordinating an event further comprises the steps of identifying a complementary product or service for the event and booking the complementary product or service. In some embodiments, the step of booking the complementary product or service includes the step of entering the desired event into an electronic calendar curated by a provider of the complementary product or service. In some embodiments, the complementary service is selected from the group consisting of: a catering service, an entertainment service, a logistical service, and combinations thereof. In some embodiments, the complementary product is selected from the group consisting of: lodging, transportation, apparel, merchandise, food and/or beverages, and combinations thereof. In some embodiments, the complementary product or service is defined and automatically booked based on predetermined preferences of the user. In some embodiments, the complementary product or service is defined and automatically booked based on expertise of the provider of the complementary product or service.

In some embodiments, the method of coordinating an event further comprises the step of identifying an availability of potential invitees based on scheduling information provided by at least one electronic calendar curated by the potential invitees.

In some embodiments, the characteristic is the start time of the event, wherein the method further includes the step of determining available start times of the event based on scheduling information provided by an electronic calendar curated by the user.

Other objects, features, and advantages of the present invention will become apparent upon reading the following detailed description in conjunction with the drawings and the claims.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a flow chart showing a process of facilitating the scheduling of meetings consistent with one embodiment of the present disclosure.

FIG. 2 is a flow chart showing a further embodiment of the process of facilitating the scheduling of meetings portrayed in FIG. 1.

FIG. 3 is a flow chart showing a further embodiment of the process of facilitating the scheduling of meetings portrayed in FIG. 1.

FIG. 4 is a flow chart showing a method for coordinating an event for a user consistent with some embodiments of the method portrayed in FIG. 1.

FIG. 5 portrays a further embodiment of the method shown in FIG. 4.

FIG. 6 is a flow chart showing a further embodiment of the method for coordinating an event for a user portrayed in FIG. 4.

FIG. 7 portrays a further embodiment of the method shown in FIG. 6.

FIG. 8 is a flow chart showing a further embodiment of the process of facilitating the scheduling of meetings portrayed in FIG. 1.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In some embodiments, the present disclosure is directed to a system and method that electronically searches for people and entities with certain characteristics. Once these people and/or entities are identified, there is a search to see if there is a common available time for a meeting, both with respect to time and location. Characteristics can be either defined automatically by the system or defined manually by an initiator or user. In some embodiments, characteristics are automatically defined by the system according to the preferences of the user. In some embodiments, characteristics are automatically defined according to the expertise of a service provider and/or product retailer.

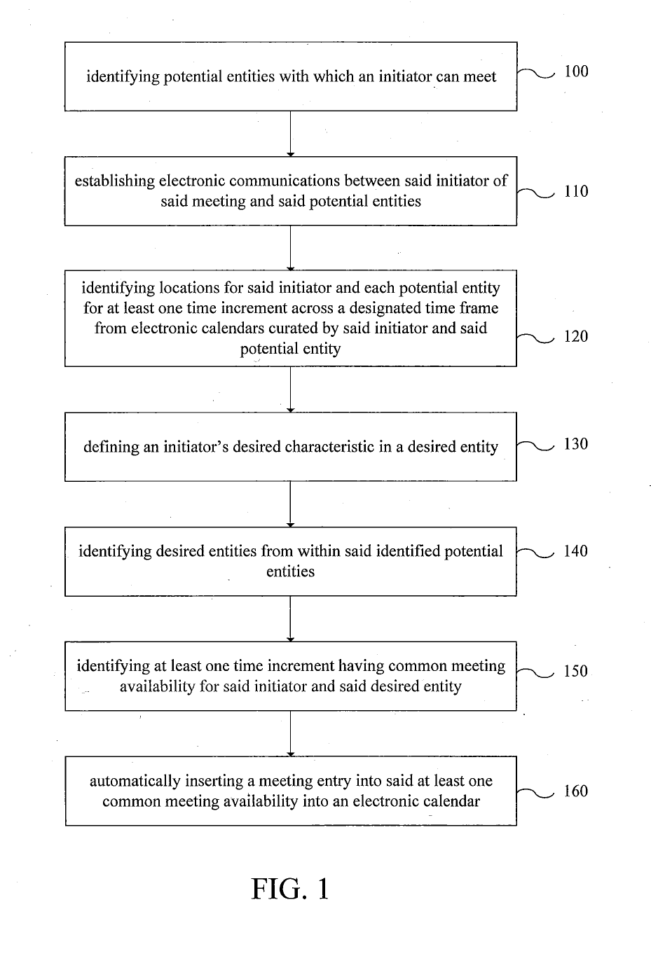

In some embodiments of the present disclosure, as shows in FIG. 1, the method for facilitating scheduling of meetings comprises: identifying 100 potential entities with which an initiator can meet and establishing 110 electronic communications between the initiator of the meeting and those potential entities; identifying 120 locations for the initiator and each potential entity for at least one time increment across a designated time frame from electronic calendars curated by the initiator and the potential entities; defining 130 an initiator's desired characteristic in a desired entity; identifying 140 desired entities from within the identified potential entities; identifying 150 at least one time increment having common meeting availability for the initiator and the desired entity; and automatically inserting 160 a meeting entry into at least one common meeting availability into an electronic calendar.

In some embodiments, the entity is an individual, group of individuals, or a company. In some embodiments, the entity is a service provider or a product retailer. In some embodiments, the system of the present disclosure electronically searches for service providers and/or product retailers based on at least one characteristic. In some embodiments, the initiator defines multiple characteristics for the service provider and/or product retailer. Once those service providers and/or product retailers with the desired characteristic or characteristics are identified, there is a search of electronic calendars curated by the initiator and the service provider and/or product retailer to see if there is a common available time for a meeting. In some embodiments, common availability is with respect to both time and location.

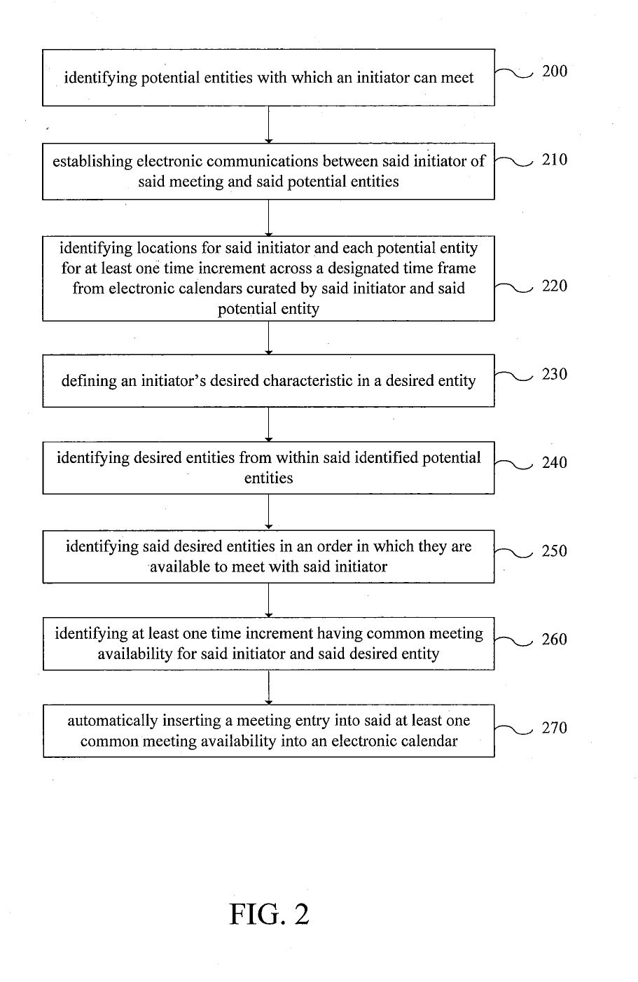

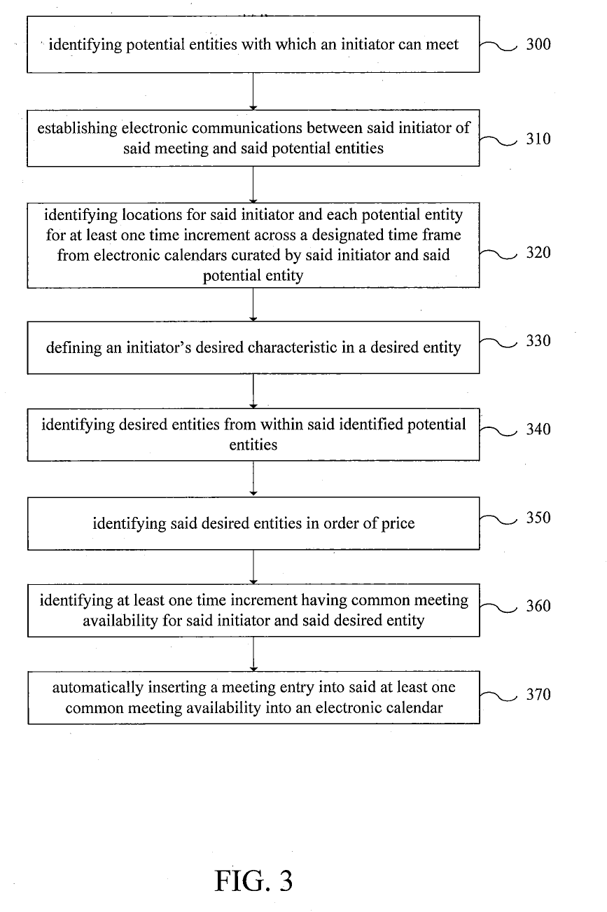

In some embodiments, if a common available time for meetings between the initiator and the service providers and/or product retailers is identified, a meeting can automatically be set on electronic calendars curated by the respective parties. In some embodiments, the initiator is provided with a list of all available service providers and/or product retailers with common available times for a meeting. In some embodiments, the list is sortable to allow an initiator to organize and analyze the returned data to identify the service providers and/or product retailers and meeting times that best suit their needs. As shown in FIGS. 2 and 3, in some embodiments desired entities are identified 250 in an order in which they are available to meet with the initiator or identified 350 in order of price. In some embodiments, the list is sortable by service provider/product retailer name, location, price, crowd-sourced ratings, distance from the initiator, and any other suitable metric.

If a match is made, a meeting can automatically be set on an electronic calendar of the initiator. In some embodiments, the initiator can override an automatic meeting entry on his calendar. This is helpful in case the initiator prefers a different meeting or just does not want to meet that person or entity.

In some embodiments, there is a channel of electronic communication between a person and potential meeting attendees. This is as simple as both being part of the same local area network (such as an intra-company network) or even both being connected to the Internet. In some embodiments, the system includes a database of person and entity information that is accessible via a wired or wireless connection with at least one connected user device. In some embodiments, the system also includes a software application configured to allow a user to search and sort the data within the database, and further communicate with those parties entered in the database and their electronic calendars.

Meeting availability requires the parties to be at a common location (or at least in close proximity) at the same time. In some embodiments, there is a need for each party to have an electronic calendar including highly specific location information where possible.

It is advantageous for each party to set a daily location for each day they wish to be available for meetings. In some embodiments, a default location can be set. For example, if the participant does not set a location for a particular day, then a predefined location (such as home city) is entered. In some embodiments, a location of the user can be determined through global positioning systems, IP addresses, currently connected WiFi networks, cellular telephone towers, and the like and/or combinations thereof.

Many electronic calendar programs, like MICROSOFT OUTLOOK® (Microsoft Corp., Redmond Wash.), have a feature that allows users to set the location for meetings or for a certain time frame.

In some embodiments, once there is a channel of communication and the parties set their locations, the person who wants to initiate meetings identifies at least one characteristic of the person or entity he wants to meet.

In some cases, this characteristic is shared by both the initiator and the potential persons or entities to meet. For example, the initiator may be in the diamond business. He may want to identify all other people in the diamond business who are in New York or Amsterdam or Tel Aviv at the same time. This way he can arrange meetings with them. Alternatively, he could be a salesman for clothing and he may want to identify buyers of clothing.

In some embodiments, a characteristic includes titles, company affiliation, company position, conference name, attribute, profession, industry, location, age, group affiliation, specific interest, proximity to the user, and the like. Thus, an initiator can search for representatives of a specific company. An initiator can restrict the search to just CEOs or Buyers or other relevant people. A specific profession or industry can be targeted.

In some embodiments, a productivity rating is given for the persons or entities included in the database. In this way, the initiator can limit the meeting to just those people or entities with high productivity and exclude less efficient people or entities.

In some embodiments, the initiator establishes a prioritization protocol. For example, the initiator may prefer CEOs to Buyers. He can set the order or priority of available parties, based on any criteria. In this way, meetings can be set with the most meaningful people first.

In some embodiments, the initiator defines a characteristic of persons he would like to meet based solely on characteristics desired in the other party. For example, he may be traveling overseas and get a toothache while in Zurich. Thus, he wants to identify dentists in Zurich who have matching availability. In such a situation, the characteristic is not indicative of the initiator, but is indicative of the person who the initiator wants to meet.

Once a characteristic is defined, the system searches through the persons and entities with which there is a communication link to identify parties with this characteristic. As discussed above, after the matching people or entities are found, the system searches the electronic calendar of the respective parties with the characteristic and also the initiator to identify a common meeting availability with respect to both time and location availability. Here is it important for the availability to be for both criteria. It does not matter if there is a common open time slot if the respective parties are not located geographically close to each other or incapable to doing so. The match must be made with respect to both time and location. In some embodiments, the availability may be marked only on the initiator's calendar.

In some embodiments, the system identifies a time frame having the greatest number of common meeting availabilities with different people or entities. After doing the search, the system highlights how many matches there are in selected time frames. For example, April 1 to 10 may have 12 available meetings, but April 11 to 20 may have 20 available meetings. In this way, the initiator can determine the best time to travel or otherwise be available to attend meetings.

The system allows users to more accurately coordinate travel plans. For example, suppose a person wished to travel to Shanghai to meet cell phone manufacturers. The user would designate cell phone manufacturers as the characteristic. Then, the system would determine available meeting dates and determine precisely how long the user would need to travel in order to fit in all the meetings. By way of example, the system may determine it will take a month to fit in all these meetings, based on searching the electronic calendars of the involved people or entities. In some embodiments, the user identifies all the meetings that must take place on a certain trip and the system returns the best times in which to travel to attend to all of those meetings.

In some embodiments, even if there is no common availability, the initiator is advised of a party's location. For example, an initiator may be trying to set a meeting with a friend, but there is no meeting availability during the selected time frame. Instead the initiator receives back a communication that the person is, for example, in London.

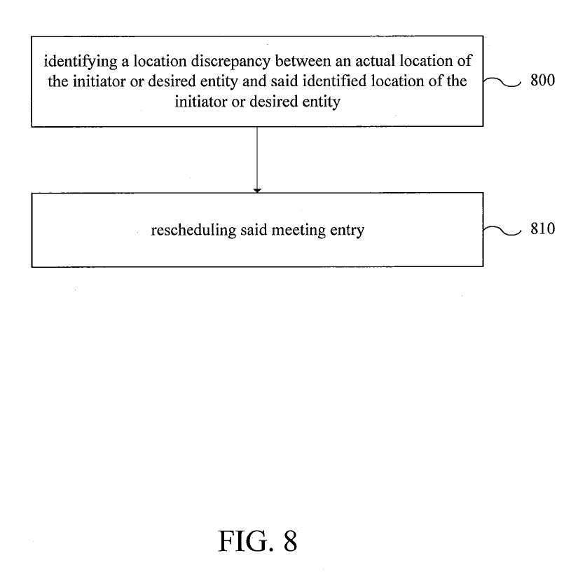

In some embodiments, such as that shown in FIG. 8, the system identifies 800 location discrepancy with the parties scheduled to meet. In some embodiments, when parties scheduled to attend certain meetings or events are not in the scheduled/expected location to attend that meeting, the system provides an alert to the parties of that fact. In some embodiments, the alert is a pop-up window on a user's electronic device. As used herein, in some embodiments, the term “the scheduled/expected location” can refer to either the location of a meeting/event or to the area that a meeting invitee must be in order to reasonably travel to arrive at the meeting/event on time. In some embodiments, when it is determined that a user is will be unable to attend a previously scheduled meeting or event based on their current location or the addition of new meetings or events to the user's electronic calendar, it is cancelled or rescheduled 810. In some embodiments, the system automatically reschedules the meeting. In some embodiments, the rescheduling is based on the contents of the meeting participant's electronic calendars. In some embodiments, the meeting is rescheduled based on the locations of the meeting participants. In some embodiments, the meeting is rescheduled manually by the meeting participants. In some embodiments, the meeting is not rescheduled.

Stated succinctly, in some embodiments, the system serves as a type of social filter. The user identifies some feature or characteristic of a person or entity he wants to meet, and then the system identifies those people or entities with common availability in terms of time and location. This way it enables parties to quickly meet and facilitate those meetings.

In some embodiments, the initiator or user identifies a desired event, and the system and method of the present disclosure automatically provides the user with the ability to specify all aspects of the event and book the entire event all at one time. In some embodiments, the user has access to a database of events and associated venues. For example, the events held in the database may be previously scheduled sporting events, concerts, shows, and the like. The events held in the database may also be heretofore unplanned events, such as weddings, parties, fundraisers, and the like. In some embodiments, the events are more common such as going out to dinner, going to the gym, and the like.

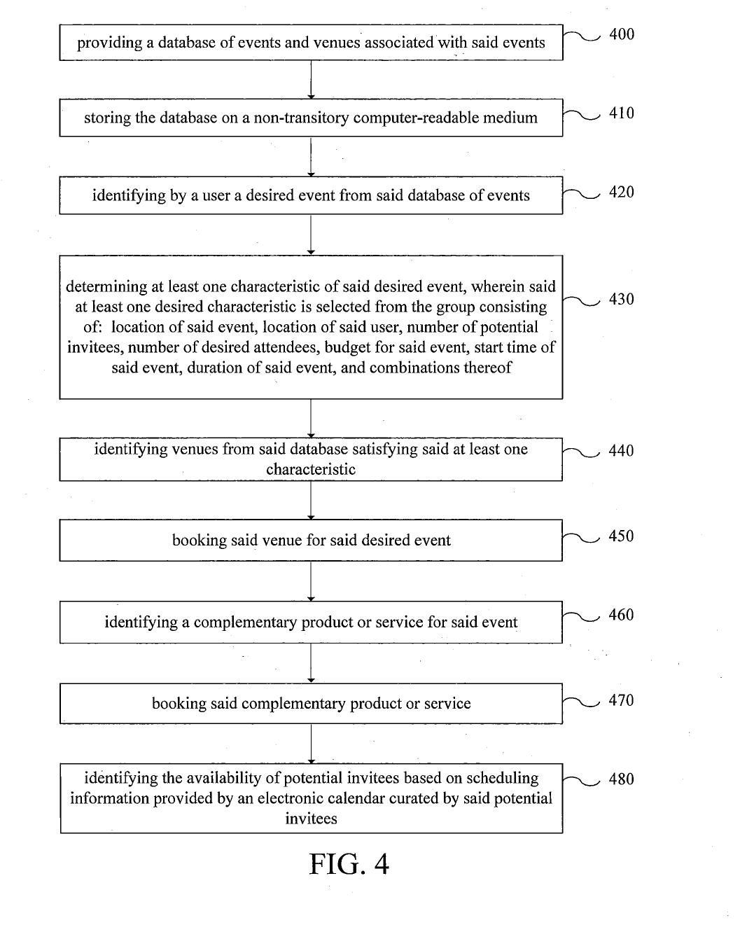

As shown in FIG. 4, a database is first provided 400 with data including events and venues associated with those events. In some embodiments, the database is stored 410 on a non-transitory computer-readable medium. A user then identifies 420 a desired event held within that database. The user then determines 430 at least one characteristic of the desired event. These characteristics help to better define the event and eliminate undesirable venues for that event. The system then identifies 440 venues from the database that can host or facilitate the event and satisfy the characteristic determined in step 430. The user then proceeds to book 450 a venue.

In some embodiments, once a user books 450 a venue for an event, the system identifies 460 a complementary product or service for that event and allows a user to also book 470 that complementary product or service. In some embodiments, the complementary product or service is a catering service, an entertainment service, and/or a logistical service. In some embodiments, a complementary product or service is for use during and/or along with the event, such as catering services and music services would be for a wedding. In some embodiments, a complementary product or service is for use before or after an event, such as a rental car for transporting the user to the event and a hotel room in close proximity to the event location to stay after the event is over or before it starts. In some embodiments, the complimentary product or service is further tailored specifically for the event or the timing of the event. For example, the complementary service might be a catering service where a user will ultimately define the menu provided by the catering service, or, the catering service may automatically provide a food and beverage menu to match the season in which the desired even is to be scheduled.

In some embodiments, complementary products and services are organized based upon user preferences defined for and/or learned by the system of the present disclosure. For example, in some embodiments where the desired event is a sporting event, the system of the present disclosure knows to also book a small rental car and a three-star hotel within a 10 minute drive of the location of the sporting event, based on previous events organized through the system for the user and prior preferences defined by the user. In some embodiments, the desired event is a trip to a different city and the system provides complementary products and services for that trip. For example, a user instructs the system that the desired event is a trip to Hong Kong for the next week, which causes the system to book flights, lodging, and transportation (e.g. rental car or taxi services) for the duration of that trip. In some embodiments, traffic information is utilized by the system to find the complementary product or service that best matches the preferences of the user. In some embodiments, user preferences may include price, location, number of potential invitees, exclusivity, and the like.

Thus the present invention streamlines the process whereby a user coordinates and schedules an event for one to any number of invitees. A user may simply identify a desired event and the system and method of the present disclosure facilitates the event with the user having as little or as much input in the process and is desired by the user. For example, should the user be planning a wedding, the system may automatically order a wine service with dinner. Alternatively, the user may decide to take greater control over the planning process and order a wine service for the invitees. The user may then decide whether to specify the specific wines and wine providers for the event, or may instead leave those decisions to the system and the wine service provider booked by the system.

In some embodiments, availability of potential invitees is identified 480 based on scheduling information provided by an electronic calendar curated by the potential invitees. In these embodiments, at least one electronic calendar is used to organize the schedules of the potential invitees. In some embodiments, the number of electronic calendars is any number of calendars necessary to accurately reflect the times during which potential invitees are available to attend events and/or unavailable for reasons such as a prior engagement, being located in a place where it would be impossible to arrive at an event in time, or leave the event with sufficient time to arrive at previously scheduled event. During identification step 480, in some embodiments, the system of the present disclosure analyzes the electronic calendars of the potential invitees and identifies the times that all potential invitees are available to attend the desired event booked in step 440.

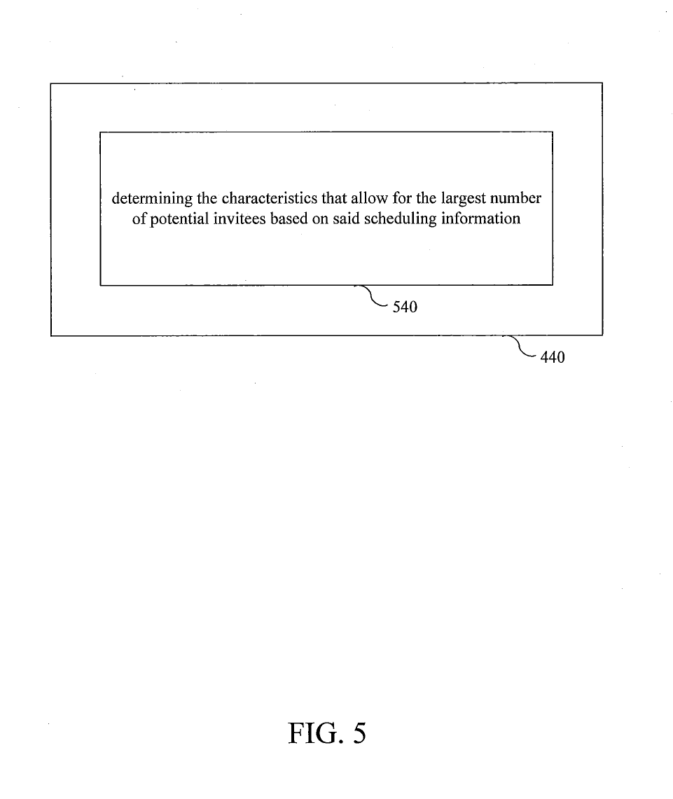

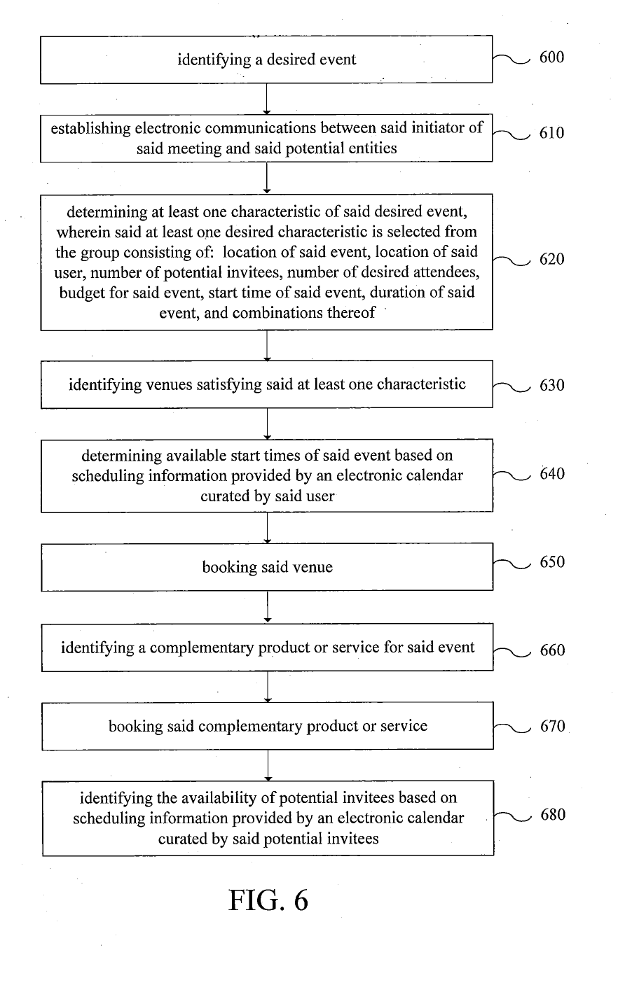

It is possible that the system will be unable to identify a time in which all potential invitees are available to attend the desired event. As shown in FIG. 5, some embodiments of the method of the present disclosure include the step of determining 540 the characteristics that allow for the largest number of potential invitees based on scheduling information. In some embodiments, determining step 540 identifies the desired event starting time that would allow the largest percentage of potential invitees to attend. In some embodiments, determining step 540 identifies the starting time and duration for the desired event that would allow the largest percentage of potential invitees to attend. Similar to the method identified in FIG. 5, the method of FIG. 6 includes the step of determining 640 available start times of a desired event based on scheduling information provided by an electronic calendar curated by a user. Thus, the system enables the desired events to be organized with significantly increased efficiency.

In some embodiments, desired events are presented to the user prior to booking as a series of available packages based on user preferences, product and service availability, and the like. For example, a user desiring a space to hold a wedding may request available wedding venues. In response to this request, the system analyzes the user's electronic calendar and identifies those venues that are available at the times when the user is available to host the wedding. For each available time and each available venue, the user is also presented with a list of potential invitees and/or complementary products/services that would be available to the user. By way of example, a user might identify a venue and date that are ideal, but realize booking an event with those characteristics would result in a smaller list of potential invitees and eliminate a preferred provider of musical services. The user may then view less ideal dates to determine if the combination with more potential invitees and preferred service providers and/or product retailers is sufficient to overcome the choice of a less ideal date. That all of these considerations are possible within one system and prior to the booking of any event is highly advantageous to the user.

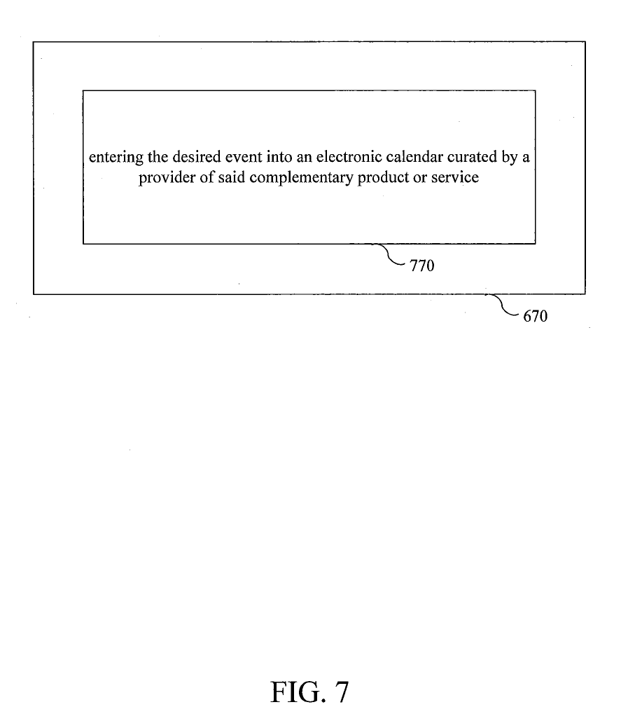

In some embodiments, once the desired event is booked, the system alerts all relevant parties of the desired event. In some embodiments, the system automatically enters the desired event into the electronic calendars curated by the user and/or the invitees. As shown in FIG. 7, in some embodiments, the desired event is entered 770 in an electronic calendar curated by a provider of the complementary product or service as well. Entering step 770 advantageously allows a service provider and/or product retailer to more efficiently handle their workflow and the workflow of their employees. For example, upon the booking of a desired event at a conference center with a complementary catering service by a user, an electronic calendar curated by a catering company may be updated to reflect all information about the new event, such as type of event, number of invitees, location, duration, and the like. Employee schedules and responsibilities for that date may thusly be coordinated far in advance of the actual event.

In some embodiments, the systems and methods of the present disclosure are applied to the scheduling of transportation for people and for goods. For example, parents could set up electronic calendars for their children that include entries for activities that the child will attend (the “events”) and for which transportation is necessary. For example, the event could be a day of school, the presence of which on an electronic calendar alerts a bussing company as to the location of the child, the location of the school, and when the child would need to arrive at the school to attend class. When combined with the location information of other children attending the same school, the bussing company constructs an efficient bussing schedule to transport all of the children to the necessary locations. As discussed above, the systems and methods of the instant invention also allow for monitoring and real-time updating of an individual's location and can adjust electronic calendars accordingly. When applied to this example, the system recognize changes in the electronic calendar of the child, such as the child will not attend school due to sickness or some other reason, and reroute the bus to reflect not needing to stop for that child. Additionally, the system can identify a location discrepancy (such as in the event the family is away on vacation), and the system automatically reorganizes the bussing schedule to account for the fact that the child will not need bussing services that day.

In another example, the system and method are used to facilitate efficient delivery of packages and or other correspondence through a courier service such as UPS® (United Parcel Service of America, Inc., Sandy Springs, Ga.). In this example, delivery or pick-up of a package (the “event”) may be scheduled based on the contents of a user's electronic calendar (i.e. when the user is scheduled to be home) and/or the relative location of delivery vehicles or personnel. If there is a discrepancy between the user and the scheduled/expected location of that user (the user is not at home or cannot reasonably be expected to arrive home in time to accept delivery), delivery of the package may be cancelled and/or rescheduled. In some embodiments, the cancelled and/or rescheduled delivery identifies a new scheduled/expected location, and the delivery vehicle may be rerouted. As discussed above, each cancellation or rescheduling can be handled automatically, manually, or with/without the use of an alert to the user such as a pop-up window.

In some embodiments, a search is performed through use of keywords or terms selected from a finite number of available terms, such as through the use of a dropdown menu. In some embodiments, a search is performed through natural language recognition. For example, a user might request of the system “I need a car for tomorrow,” in response to which the system would proceed through the above-identified method steps that are relevant to fulfilling the user's request, such as identifying rental car companies in close proximity to the user and reserving a time to pick up the rental car based on the information in the user's calendar. In some embodiments, the system further includes suitable hardware for facilitating natural language searching, for example input devices (e.g. microphones or keyboards), software, sufficient CPU processing capabilities to process user inputs, and/or databases enabling parsing of natural language inputs to quickly execute national language recognition.

Searching of databases and application files is known in the trade.

In computer science, a search data structure is any data structure that allows the efficient retrieval of specific items from a set of items, such as a specific record from a database.

The simplest, and least efficient, search structure is merely an unordered sequential list of all the items. Locating the desired item in such a list, by the linear search method, inevitably requires a number of operations proportional to the number n of items, in the worst case as well as in the average case. Useful search data structures allow faster retrieval; however, they are limited to queries of some specific kind.

Static search structures are designed for answering many queries on a fixed database. Dynamic structures also allow insertion, deletion, or modification of items between successive queries. In the dynamic structure, one must also consider the cost of fixing the search structure to account for the changes in the database.

The simplest kind of query is to locate a record that has a specific field (the key) equal to a specified value v. Other common kinds of query are “find the item with smallest (or largest) key value”, “find the item with largest key value not exceeding v”, “find all items with key values between specified bounds vₘᵢₙ and vₘₐₓ”.

In certain databases the key values may be points in some multi-dimensional space. For example, the key may be a geographic position (latitude and longitude) on the Earth. In that case, common kinds of queries are find the record with a key closest to a given point v″, or “find all items whose key lies at a given distance from v”, or “find all items within a specified region R of the space.”

There are several categories of search engine software: Web search or full-text search, database or structured data search, and mixed or enterprise search. The largest web search engines such as Google and Yahoo! utilize tens or hundreds of thousands of computers to process billions of web pages and return results for thousands of searches per second. The high volume of queries and text processing requires the software to run in a highly distributed environment with a high degree of redundancy′

Searching for text-based content in databases or other structured data formats (XML, CSV, etc.) presents some special challenges and opportunities which a number of specialized search engines resolve. Databases are slow when solving complex queries with multiple logical or string matching arguments. Databases allow logical queries which full-text search do not (use of multi-field Boolean logic for instance). There is no crawling necessary for a database since the data is already structured, but it is often necessary to index the data in a more compact form designed to allow for faster search.

Database search engines were initially (and still usually are) included with major database software products. As such, they are usually called indexing engines.

In more advanced Database search systems, relational databases are indexed by compounding multiple tables into a single table containing only the fields that need to be queried (or displayed in search results). The actual data matching engines can include any functions from basic string matching, normalization, and/or transformation.

According to the herein Invention, the key word(s) are determined based on the search characteristic of the person(s) that are to be identified. In some embodiments, the system automatically determines the key words to use to identify the relevant people, and then searches the electronic calendars to find available meeting times, based both on time and location.

As described herein, the user defines a characteristic for persons with whom a meeting shall be held. Then the system identifies persons with this characteristic. Thereafter, the system searches electronic calendars of these persons and also the user to identify a common meeting availability with respect to both time and location availability.

One or more embodiments of the present invention have been described. Nevertheless, it will be understood that various modifications may be made without departing from the spirit and scope of the invention. Accordingly, other embodiments are within the scope of the following claims.

1. A method for facilitating scheduling of meetings, comprising:
identifying potential entities with which an initiator can meet;
establishing electronic communication between said initiator and said potential entities;
identifying locations for said initiator and each potential entity for at least one time increment across a designated time frame from electronic calendars curated by said initiator and said potential entity;
defining an initiator's desired characteristic in a desired entity;
identifying desired entities from within said identified potential entities;
identifying at least one time increment having common meeting availability for said initiator and said desired entity based on said identified locations for said initiator and said desired entities; and
automatically inserting a meeting entry at said at least one common meeting availability into an electronic calendar.

2. The method for facilitating scheduling of meetings according to claim 1, wherein said initiator can override insertion of an automatic meeting entry.

3. The method for facilitating scheduling of meetings according to claim 1, further comprising identifying said desired entities in an order in which they are available to meet with said initiator.

4. The method for facilitating scheduling of meetings according to claim 1, further comprising identifying said desired entities in order of price.

5. The method for facilitating scheduling of meetings according to claim 1, wherein said potential entities are service providers or product retailers.

6. The method for facilitating scheduling of meetings according to claim 1, wherein said desired characteristic is selected from the group consisting of: hours or operation, availability, price, service offered, product offered, crowd-sourced ratings, and combinations thereof.

7. The method for facilitating scheduling of meetings according to claim 1, wherein said at least one common meeting availability includes both time and location availability.

8. The method for facilitating scheduling of meetings according to claim 1, further comprising the steps of:
identifying a location discrepancy between an actual location of the initiator or desired entity and said identified location of the initiator or desired entity; and
rescheduling said meeting entry.

9. A method of coordinating an event for a user comprising the steps of:
providing a database of events and venues associated with said events;
storing the database on a non-transitory computer-readable medium;
identifying by a user a desired event from said database of events;
determining at least one characteristic of said desired event, wherein said at least one desired characteristic is selected from the group consisting of: location of said event, location of said user, number of potential invitees, number of desired attendees, budget for said event, start time of said event, duration of said event, and combinations thereof;
identifying venues from said database satisfying said at least one characteristic; and
booking said venue for said desired event.

10. The method of coordinating an event according to claim 9, further comprising the steps of:
identifying a complementary product or service for said event; and
booking said complementary product or service.

11. The method of coordinating an event according to claim 10, wherein said complementary service is selected from the group consisting of: a catering service, an entertainment service, a logistical service, and combinations thereof.

12. The method of coordinating an event according to claim 10, wherein said complementary product is selected from the group consisting of: lodging, transportation, apparel, merchandise, food and/or beverages, and combinations thereof.

13. The method of coordinating an event according to claim 9, further comprising the step of:
identifying an availability of potential invitees based on scheduling information provided by at least one electronic calendar curated by said potential invitees.

14. The method of coordinating an event according to claim 11, wherein the step of booking said venue includes the step of determining characteristics that allow for a largest number of available potential invitees based on said scheduling information.

15. The method of coordinating an event according to claim 9, wherein said characteristic is said start time of said event, wherein the method further includes the step of determining available start times of said event based on scheduling information provided by an electronic calendar curated by said user.

16. The method of coordinating an event according to claim 9, wherein the step of booking said complementary product or service includes the step of entering said desired event into an electronic calendar curated by a provider of said complementary product or service.

17. The method of coordinating an event according to claim 10, wherein said complementary product or service is defined and automatically booked based on predetermined preferences of said user.

18. The method of coordinating an event according to claim 10, wherein said complementary product or service is defined and automatically booked based on expertise of said provider of said complementary product or service.

19. The method of coordinating an event according to claim 9, further comprising the step of automatically inserting said desired event into electronic calendars curated by said user and said potential invitees.

20. A method of automatically scheduling an itinerary for a user comprising the steps of:
providing, on a non-transitory computer readable medium, a database of events and venues to facilitate said events, said database including location and availability data associated said venues;
identifying a location of a user;
identifying a plurality of desired events from said database;
identifying at least one venue from said database available to provide each of said plurality of desired events;
automatically scheduling said desired events for an identified venue at such times that said user may attend each desired event during the course of a trip; and
routing said user to each scheduled desired event such that said user may attend each scheduled desired event during the course of said trip in an efficient manner.

21. The method of automatically scheduling an itinerary for a user according to claim 20, wherein the availability of a certain venue includes the hours of operation for said venue, products offered by said venue, services offered by said venue, and combinations thereof.

22. The method of automatically scheduling an itinerary for a user according to claim 20, wherein the step of routing said user to each scheduled desired event such that said user may attend each scheduled desired event during the course of said trip in an efficient matter further includes the step of manually defining by a user the time of at least one event.

23. The method of automatically scheduling an itinerary for a user according to claim 20, wherein the step of routing said user to each scheduled desired event such that said user may attend each scheduled desired event during the course of said trip in an efficient matter further includes the step of manually defining by a user the location of at least one event.

24. The method of automatically scheduling an itinerary for a user according to claim 20, wherein the step of routing said user to each scheduled desired event such that said user may attend each scheduled desired event during the course of said trip in an efficient manner further includes the step of manually defining by a user said identified venue.

25. The method of automatically scheduling an itinerary for a user according to claim 20 further including the step of identifying at least one complementary product or service for said trip.

26. The method of automatically scheduling an itinerary for a user according to claim 25, wherein said complementary product is selected from the group consisting of:
lodging, transportation, apparel, merchandise, food and/or beverages, and combinations thereof.

27. The method of automatically scheduling an itinerary for a user according to claim 20, wherein said identified venue is determined by crowd-sourced rating for said desired event.

28. The method of automatically scheduling an itinerary for a user according to claim 20, wherein multiple venues are identified for each desired event and the method further includes the step of manually selecting by said user said identified venue.

29. The method of automatically scheduling an itinerary for a user according to claim 20, wherein the step of identifying a location of a user uses a global positioning system on said user's mobile device, an electronic calendar curated by said user with location information for events in said calendar, or both.

30. The method of automatically scheduling an itinerary for a user according to claim 26, wherein the step of routing said user to each scheduled desired event such that said user may attend each scheduled desired event during the course of said trip in an efficient manner further includes the step of routing said user based on the identified most efficient modes of transportation for use during the course of the trip and scheduling the user to travel via those modes of transportation.
